(19) United States
(12) Patent Application Publication
(10) Pub. No.: US 2007/0008597 A1
(43) Pub. Date: Jan. 11, 2007

(54) Computer generated hologram optical element

(76) Inventors: Masachika Watanabe, Tokyo (JP); Mitsuru Kitamura, Tokyo (JP); Koji Eto, Tokyo (JP)

Correspondence Address: LADAS & PARRY LLP, 224 SOUTH MICHIGAN AVENUE, SUITE 1600, CHICAGO, IL, 60604, US

(21) Appl. No.: 11/481,263

(22) Filed: Jul. 5, 2006

(30) Foreign Application Priority Data
Jul. 6, 2005 (JP) 2005-198163

(51) Int. Cl. G03H 1/02

(52) U.S. Cl. 359/3; 359/9

(57) ABSTRACT

A main object of the present invention is to provide a computer-generated hologram optical element with little decline of the image converting function even when a pollutant such as oil and water is adhered to the surface. To achieve the object, the present invention provides a computer-generated hologram optical element comprising: a transmission type Fourier transform hologram comprising a substrate, and an image converting layer formed on the substrate and having a function as a Fourier transform lens; a diffraction function layer disposed on the image converting layer of the transmission type Fourier transform hologram and having a certain refractive index difference with respect to the image converting layer; and a protection layer formed on the diffraction function layer.

### BACKGROUND OF THE INVENTION

1. Field of the Invention

The present invention relates to a computer generated hologram optical element having a function as a Fourier transform lens. More specifically, it relates to a computer generated hologram optical element with little decline of the image converting function even when a pollutant is adhered on the surface.

2. Description of the Related Art

The hologram is produced by having two lights of the same wavelength (object light and reference light) interfere with each other so as to have the wave surface of the object light recorded on a sensitive material as interference fringes. If a light of the same condition as the original reference light is directed to the hologram, the diffraction phenomenon is generated by the interference fringes so that the same wave surface as the original object light can be reproduced. The hologram can be classified into several kinds (surface relief type hologram, volume type hologram, or the like) according to the recording form of the interference fringes generated by the interference of a laser beam or a light of the excellent coherence property.

The hologram is often used for the security application, or the like, utilizing the characteristics of being difficult in copying the same design. In particular, a surface relief type hologram for recording the interference fringes by applying a minute concavo-convex shape on the hologram formed layer surface is commonly used. Conventionally, the reflection type ones have been the mainstream as such a hologram, however, recently, a transmission type hologram has been developed so that the transmission type hologram having the function as a computer generated hologram is particularly attracting the attention.

Since the transmission type computer generated hologram has a unique nature wherein an incident light is converted to a predetermined image by directing a light from a point light source, application development, which has been impossible for the conventional reflection type hologram, is discussed. For example, the Japanese Patent Application Laid-Open (JP-A) No. 2004-126535 discloses an application as a hologram observation tool, wherein two transmission type holograms are set onto a frame of the glasses instead of the lenses to observe a predetermined image by observing the point light source with the glasses on.

Moreover, the JP-A No. 2004-77548 discloses a novel “fan” with a transmission type computer generated hologram fitted in the “fan” to further enjoy something else such as a mark or illustration together with the pattern on the fan itself. Accordingly, the transmission type computer generated hologram allows novel application developments, which cannot be provided by the conventional reflection type hologram. In addition to the above-mentioned examples, various application developments such as the industrial application and the security application have been discussed.

Such a transmission type computer generated hologram in general has a configuration with an image converting layer having a minute concavo-convex shape formed on a transparent substrate. As the image converting layer, for example, those having a function as a Fourier transform lens are known. As the image converting layer having the function as the Fourier transform lens, those of an embossed type phase hologram and those of a film type amplitude hologram are known as the mass producible type.

Here, the transmission type computer generated hologram is for converting a light incident from a point light source to a desired optical image utilizing the refractive index difference between the image converting layer and the air, however, a problem is involved in that the obtained optical image is disturbed due to the refractive index difference change by the adhesion of oil, water, or the like onto the surface of the image converting layer.

In particular, since a minute concavo-convex shape is formed on the surface of the embossed type computer generated hologram and the concavo-convex shape is exposed to the air interface, by the adhesion of oil, water, or the like onto the surface of the image converting layer, the concavo-convex portion is buried. As a result, an optical image cannot be obtained to cause the computer generated hologram problematic. Due to the problems, it has been difficult to obtain a highly practical one in the case of the transmission type computer generated hologram.

### SUMMARY OF THE INVETNION

The present invention has been achieved in view of the above-mentioned problems, and a main object thereof is to provide a computer generated hologram optical element with little decline of the image converting function even when a pollutant such as oil and water is adhered to the surface.

To achieve the above-mentioned object, the present invention provides a computer generated hologram optical element comprising a transmission type Fourier transform hologram comprising: a substrate, and an image converting layer formed on the substrate and having a function as a Fourier transform lens; a diffraction function layer disposed on the image converting layer of the transmission type Fourier transform hologram and having a certain refractive index difference with respect to the image converting layer; and a protection layer formed on the diffraction function layer.

According to the present invention, since the protection layer is provided, adhesion of water, oil, or the like to the minute concavo-convex shape formed on the surface of the image converting layer of the transmission type Fourier transform hologram, or deformation of the minute concavo-convex shape of the image converting layer can be prevented. As a result, the invention can provide a computer generated hologram optical element having the excellent versatility with the image converting function maintained for a long time. Moreover, since the diffraction function layer is provided, even when the pollutant or the like is adhered on the protection layer, by wiping off the pollutant, a computer generated hologram optical element having the excellent image forming property can be obtained.

In the above-mentioned invention, it is preferable that the diffraction function layer is made of air. Since the diffraction function layer is made of air, the refractive index difference between the image converting layer and the diffraction function layer can be made larger so that the optical image obtained by the computer generated hologram optical element of the present invention can be made brighter without a higher order diffracted light, and thus it is advantageous. Moreover, since the depth of the minute concavo-convex shape formed in the surface of the image converting layer can be made shallower, the hologram mastering process and the copying process can be facilitated so that the production method for the computer generated hologram optical element of the present invention can be simplified. Furthermore, the refractive index of the diffraction function layer cannot be changed by the time passage, and thus it is advantageous.

Moreover, in the above-mentioned invention, the diffraction function layer and the protection layer may be formed integrally with the same resin. Since the diffraction function layer and the protection layer are formed integrally with the same resin, a computer generated hologram optical element having the further excellent rigidity can be obtained.

Moreover, in the above-mentioned invention, it is preferable that the refractive index difference between the diffraction function layer and the image converting layer is in a range of 0.75×(λ₀/D)×(N−1)/N to 1.25×(λ₀/D)×(N−1)/N. Since the refractive index difference between the diffraction function layer and the image converting layer is in the above-mentioned range, for example when the diffraction function layer is made of air, a bright optical image can be reproduced. Moreover, advantages such as the reduction of an unnecessary diffracted image, or the like may be obtained.

Here, the above-mentioned λ₀ represents the reference wavelength; the above-mentioned D represents the maximum depth of the minute concavo-convex shape formed on the surface of the image converting layer; and the above-mentioned N represents the number of the steps of the minute concavo-convex shaped formed on the surface of the image converting layer.

Moreover, in the above-mentioned invention, printing may be applied to the protection layer. Since printing is applied to the protection layer, a computer generated hologram optical element with a rich design property can be obtained, and thus the computer generated hologram optical element of the present invention can be suitable for the application as the toys, or the like.

Furthermore, it is preferable that the computer generated hologram optical element in the above-mentioned invention has an anti-reflection layer. Since the anti-reflection layer is provided, for example disturbance of the image derived from the multiple reflection of an incident light, or the like can be prevented.

The present invention provides the effect of obtaining a computer generated hologram optical element with little decline of the image converting function even when a pollutant is adhered on the surface.

### BRIEF DESCRIPTION OF THE DRAWINGS

FIG. 1 is a schematic cross sectional view showing an example of a computer generated hologram optical element of the present invention;

FIG. 2 is a schematic cross sectional view showing another example of a computer generated hologram optical element of the present invention;

FIGS. 3A to 3B are schematic diagrams for explaining the Fourier transform lens function;

FIGS. 4A to 4B are schematic cross sectional views respectively showing another example of a computer generated hologram optical element of the present invention;

FIGS. 5A to 5E are schematic diagram showing an example of a production method for a transmission type Fourier transform hologram;

FIGS. 6A to 6C are schematic diagrams showing an example of a production method for a computer generated hologram optical element of the present invention; and

FIGS. 7A to 7C are schematic diagrams showing another example of a production method for a computer generated hologram optical element of the present invention.

### DETAILED DESCRIPTION OF THE INVENTION

Hereinafter, the computer generated hologram optical element of the present invention will be explained in detail.

The computer generated hologram optical element of the present invention comprises: a transmission type Fourier transform hologram having a substrate, and an image converting layer formed on the substrate and having a function as a Fourier transmission lens; a diffraction function layer formed on the image converting layer of the transmission type Fourier transform hologram and having a certain refractive index difference with respect to the image converting layer; and a protection layer formed on the diffraction function layer.

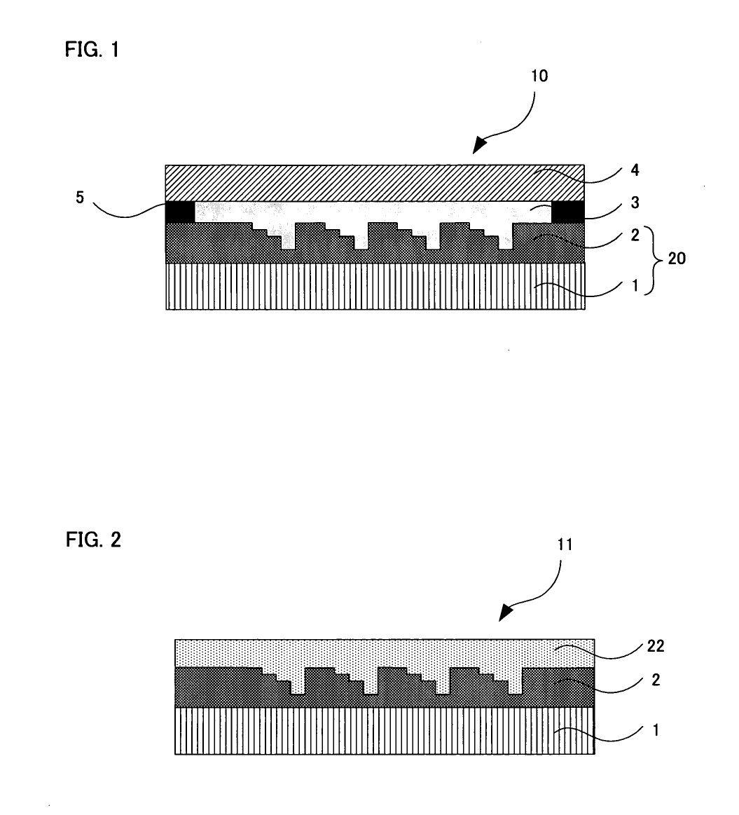

Next, the optical element of the computer generated hologram optical element of the present invention will be explained with reference to the drawings. FIG. 1 is a schematic cross sectional view showing an example of a computer generated hologram optical element of the present invention. As shown in FIG. 1, the computer generated hologram optical element 10 of the present invention comprises: a transmission type Fourier transform hologram 20 having a substrate 1, and an image converting layer 2 formed on the substrate 1; a diffraction function layer 3 formed on the image converting layer 2; and a protection layer 4 formed on the diffraction function layer 3. As shown in FIG. 1, the diffraction function layer 3 in the computer generated hologram optical element 10 of the present invention may have the thickness adjustment by an optional spacer 5, and furthermore, the spacer 5 may have a function of bonding the image converting layer 2 and the protection layer 4.

In the computer generated hologram optical element 10 of the present invention, the image converting layer 2 having a function as a Fourier transform lens has a minute concavo-convex shape formed on the surface so as to provide a desired phase distribution to a predetermined position of the image converting layer 2. By the minute concavo-convex shape, a light incident from an optional point light source is diffracted to a predetermined angle so as to form a predetermined optical image. Moreover, the diffraction function layer 3 has a certain refractive index difference with respect to the image converting layer 2, and the protection layer 4 has a function of preventing adhesion of the pollutant or the like to the minute concavo-convex shape formed on the surface of the image converting layer 2.

The diffraction function layer in the present invention has a diffraction function showing a predetermined refractive index difference with respect to the image converting layer. Since the angle of diffracting a light incident from the point light source in the image converting layer depends on the refractive index difference between the image converting layer and the diffraction function layer, if the pollutant or the like is adhered onto the image converting layer, the refractive index difference differs from the state before the pollutant adhesion so that the diffraction condition of the incident light is changed. Thereby, a phenomenon of disturbance of the image to be formed by the image converting layer is generated.

However, according to the present invention, since the protection layer is formed on the diffraction function layer, change of the refractive index difference between the image converting layer and the diffraction function layer by the pollution or the like of the image converting layer can effectively be prevented. Furthermore, according to the present invention, since the diffraction function layer is provided on the image converting layer, for example even when the pollutant is adhered on the protection layer, the refractive index difference between the diffraction function layer and the image converting layer cannot be changed. Therefore, according to the present invention, a computer generated hologram optical element with little decline of the image converting function even when a pollutant is adhered on the surface can be obtained.

FIG. 2 is a schematic cross sectional view showing another example of a computer generated hologram optical element of the present invention. As shown in FIG. 2, the computer generated hologram optical element 11 of the present invention may be a composite layer 22 with the diffraction function layer and the protection layer formed integrally with the same resin.

According to the composite layer, even when the diffraction function layer and the protection layer are formed integrally, since the refractive index difference between the image converting layer and the diffraction function layer can be maintained as well as adhesion of the pollutant or the like onto the image converting layer can be prevented, the object of the present invention can be achieved.

A computer generated hologram optical element of the present invention comprises a transmission type Fourier transform hologram having a substrate and an image converting layer, a diffraction function layer, and a protection layer. Hereinafter, each configuration of the computer generated hologram optical element of the present invention will be explained in detail.

1. Diffraction Function Layer

First, the diffraction function layer in the present invention will be explained. The diffraction function layer in the present invention has a diffraction function by a certain refractive index difference with respect to the image converting layer. Since the diffraction function layer has such a diffraction function, the computer generated hologram optical element of the present invention realizes a function of converting a light incident from a point light source into a predetermined optical image.

In the present invention, the refractive index difference between the diffraction function layer and the image converting layer is not determined optionally, however, it is determined in a range capable of converting a light incident from the point light source into a predetermined optical image in the image converting layer according to the constituent material of the diffraction function layer, the constituent material of the image converting layer, the minute concavo-convex shape formed on the surface of the image converting layer, or the like. In other words, the refractive index difference between the diffraction function layer and image converting layer is not particularly limited as long as it is in a range capable of converting a light incident from a predetermined point light source into a desired image in the image converting layer.

In the present invention, the refractive index difference between the diffraction function layer and the image converting layer is preferably in a range of 0.75×(λ₀/D)×(N−1)/N to 1.25×(λ₀/D)×(N−1)/N; it is more preferably in a range of 0.9×(λ₀/D)×(N−1)/N to 1.1×(λ₀/D)×(N−1)/N; and it is particularly preferably in a range of 0.95×(λ₀/D)×(N−1)/N to 1.05×(λ₀/D)×(N−1)/N.

Here, the λ₀ is the reference wavelength and the D represents the maximum depth of the minute concavo-convex shape formed on the surface of the image converting layer. The N represents the number of the steps of the minute concavo-convex shaped formed on the surface of the image converting layer.

The reference wavelength is the representative wavelength of the point light source used for the observation of the optical image obtained by the image converting layer. For example, as the reference wavelength in the case of a white light source, 550 nm can be presented as an example. As to the above-mentioned N, for example, in the example of the computer generated hologram optical element shown in FIGS. 1 and 2, since the number of the steps in the minute concavo-convex shape is 4, N=4. Moreover, when the surface is smooth as in the case of a serrated cross section or the like, N=∞.

In particular, in the present invention, the refractive index difference is preferably in a range of 0.3 to 1.0, and it is more preferably in a range of 0.4 to 0.8. Since the refractive index difference between the diffraction function layer and the image converting layer is in the above-mentioned range, for example when the diffraction function layer is made of air, a bright optical image can be reproduced. Moreover, advantages such as the reduction of an unnecessary diffracted image, or the like may be obtained. Here, the point light source may be a monochrome light such as a laser, and moreover, it may be a white light.

The constituent material for the diffraction function layer of the present invention is not particularly limited as long as it has a refractive index capable of providing a desired refractive index difference with respect to the image converting layer to be described later. A material of any form of a liquid, a gas and a solid can be adopted. In particular, in the present invention, it is preferable to use a gaseous or solid material.

The above-mentioned gaseous material is not particularly limited as long as it has a refractive index capable of providing a desired refractive index difference with respect to the image converting layer to be described later. In particular, in the present invention, it is preferable to use air as the gaseous material. Since the diffraction function layer is made of air, the refractive index difference between the image converting layer and the diffraction function layer can be made larger so that the optical image obtained by the computer generated hologram optical element of the present invention can be made brighter without a higher order diffracted light, and thus it is advantageous. Moreover, since the depth of the minute concavo-convex shape formed in the surface of the image converting layer can be made shallower, the hologram mastering process and the copying process can be facilitated so that the production method for the computer generated hologram optical element of the present invention can be simplified. Furthermore, the refractive index of the diffraction function layer cannot be changed by the time passage, and thus it is advantageous.

The material of the solid material is not particularly limited either as long as it has a refractive index capable of providing a desired refractive index difference with respect to the image converting layer to be described later. It can be determined optionally in a range of providing the refractive index difference with respect to the image converting layer at a predetermined value according to the constituent material of the image converting layer and the minute concavo-convex shape formed in the surface of the image converting layer.

The refractive index of the solid material can be determined optionally according to the application, or the like of the computer generated hologram optical element of the present invention, and thus it is not particularly limited. Moreover, the wavelength to be the reference of the refractive index is not particularly limited either so that it may be selected optionally in a range of 400 nm to 750 nm. In particular, in the present invention, the refractive index at the 633 nm wavelength is preferably in a range of 1.3 to 2.0, and it is more preferably in a range of 1.33 to 1.8. Since the refractive index of the solid material is in the above-mentioned range, for example, the advantage such as the expansion of the selection width of the constituent material of the diffraction function layer, or the like may be obtained. Here, the refractive index can be measured with a spectral ellipsometer.

The above-mentioned solid material is not particularly limited as long as it has the above-mentioned refractive index, or the like and it has the excellent light transmission property. As such a solid material, in general, those having an 80% or more transmittance in the visible light range are preferable, and those of 90% or more are more preferable. In the case the transmittance is low, the optical image obtained by the computer generated hologram optical element of the present invention may be disturbed so as to be dark. Here, the above-mentioned transmittance of the solid material can be measured by the JIS K7361-1 (Determination of the total light transmittance of plastic-transparent materials).

Moreover, as the solid material, those having a lower haze are preferable. Specifically, those having the haze value in a range of 0.01% to 5% are preferable; those in a range of 0.01% to 3% are more preferable; and those in a range of 0.01% to 1.5% are particularly preferable. Here, as the above-mentioned haze value, a value measured based on the JIS K7105 is used.

In the present invention, it is preferable to use a plastic resin as the solid material. As the plastic resin, a thermoplastic resin, a thermosetting resin and an ionizing radiation cure resin can be presented as an example. In the present invention, any of these resins can be used preferably.

As the thermoplastic resin used in the present invention, a polyethylene based resin, a polypropylene based resin, an olefin based resin such as a cyclic polyolefin based resin, a fluorine containing resin, a silicone containing resin, or the like can be presented. As the specific examples of such a thermoplastic resin, a poly(methyl)acrylic ester or a partially hydrolyzed product thereof, a polyvinyl acetate or a hydrolyzed product thereof, a polyvinyl alcohol or a partially acetal product thereof, a triacetyl cellulose, a polyisoprene, a polybutadiene, a polychloroplene, a silicone rubber, a polystyrene, a polyvinyl butyral, a polyvinyl chloride, a polyallylate, a chlorinated polyethylene, a chlorinated polypropylene, a poly-N-vinyl carbazole or a derivative thereof, a poly-N-vinyl pyrrolidone or a derivative thereof, a copolymer of a styrene and a maleic anhydride or a half ester thereof, a copolymer having as a polymerization component at least one selected from the monomer groups capable of copolymerization such as an acrylic acid, an ester acrylate, an acrylic amide, an acrylonitrile, an ethylene, a propylene, and a vinyl chloride, a vinyl acetate, or the like can be presented. In the present invention, these thermoplastic resins may be used by only one kind or as a mixture of two or more kinds.

As such a thermosetting resin, a urea resin, a melamine resin, a phenol resin, an epoxy resin, an unsaturated polyester resin, an alkyd resin, an urethane resin, a diallyl phthalate resin, a polyimide resin, an oxetane resin, or the like can be presented.

The above-mentioned active radiation cure resin is not particularly limited either as long as it is a material having the refractive index, or the like. As such an active radiation cure resin, a photo setting type resin to be hardened by the light irradiation, an electron beam curing type resin to be hardened by the electron beam radiation, or the like can be presented. In the present invention, it is preferable to use a photo setting type resin. Since the photo setting type resin is widely utilized also in the other fields as an already established technique, it can be applied to the present invention.

Moreover, as the photo setting type resin, a photo setting type resin to be hardened by an ultraviolet ray or a visible light can be presented. In particular, it is preferable to use an ultraviolet cure resin to be hardened by the irradiation of a light of a 150 to 500 nm wavelength; more preferably of 250 to 450 nm; and further preferably of 300 to 400 nm. It is useful to use the ultraviolet cure resin from the viewpoint of the convenience of the light irradiation apparatus, or the like.

As the specific examples of the ultraviolet cure resin used in the present invention, those produced by modifying an (un) saturated polyester resin, an epoxy resin, an urethane resin, an acrylic resin, or the like with an acid containing monomer such as a (meth)acrylic acid or a glycidyl group containing monomer such as a glycidyl (meth)acrylate and a (meth)allyl glycidyl ether, a mixture of at least one kind of a modified polyester resin having 300 to 5,000 number average molecular weight, a modified epoxy resin, a modified urethane resin, a modified acrylic resin, or the like produced by modifying a hydroxyl group containing (meth)acrylic monomer such as a 2-hydroxy ethyl (meth)acrylate, a glycerine di(meth)acrylate, a trimethylol propane di(meth)acrylate, and a pentaerythritol tri(meth)acrylate with a polyfunctional isocyanate monomer such as a hexamethylene diisocyanate, a xylilene diisocyanate, a toluene diisocyanate, or the like can be presented. Moreover, as needed, a monomer of a (meth)acrylate such as an ethylene glycol mono(meth)acrylate, an ethylene glycol di(meth)acrylate, a 1,6-hexane diol mono(meth)acrylate, a 1,6-hexane diol di(meth)acrylate, a trimethylol propane di(meth)acrylate, a trimethylol propane tri(meth)acrylate, a pentaerythritol tri(meth)acrylate, a pentaerythritol tetra(meth)acrylate, a dipentaerythritol penta(meth)acrylate, and a dipentaerythritol hexa(meth)acrylate, a fluorine containing monomer, a silicon containing monomer, a sulfur containing monomer, a monomer having a fluolene skeleton, or the like may be added thereto.

In the case the diffraction function layer in the present invention is made of the solid material mentioned above, the diffraction function layer may contain a compound other than the solid material. Such a compound is not particularly limited, and it may be selected and used optionally according to the application, or the like of the computer generated hologram optical element of the present invention. As an example of the above-mentioned other compound used in the present invention, an ultraviolet absorber, a coloring agent, or the like can be presented.

The above-mentioned ultraviolet absorber is not particularly limited as long as it is a compound capable of providing a desired ultraviolet ray absorbing property to the diffraction function layer in the present invention. As the ultraviolet absorber used in the present invention, for example, a benzotriazol based ultraviolet absorber such as a 2-(2H-benzotriazol-2-yl)-p-cresol, a 2-(2H-benzotriazol-2-yl)-4-(1,1,3,3-tetramethyl butyl)phenol, a 2-(2H-benzotriazol-2-yl)-4-6-bis(1-methyl-1-phenyl ethyl)phenol, a 2-[5-chloro (2H)-benzotriazol-2-yl]-4-methyl-6-(tert-butyl) phenol, a 2,4-di-tert-butyl-6-(5-chlorobenzotriazol-2-yl) phenol, and a 2-(2H-benzotriazol-2-yl)-4,6-di-tert-pentyl phenol; a triadine based ultraviolet absorber such as a 2-(4,6-diphenyl-1,3,5-triadine-2-yl)-5-[(hexyl) oxy]-phenol; a benzophenone based ultraviolet absorber such as an octabenzone; a benzoate based ultraviolet absorber such as a 2,4-di-tert-butyl phenyl-3,5-di-tert-butyl-4-hydroxy benzoate; a liquid ultraviolet absorber such as a 2-(2H-benzotriazol-2-yl)-6-(straight chain and side chain dodecyl)-4-methyl phenol; a polymer type ultraviolet absorber such as a 2-hydroxy-4-(methacryloyloxy ethoxy benzophenone/methyl methacrylate copolymer; and additionally, an anion based water soluble polymer ultraviolet absorber, a cation based water soluble polymer ultraviolet absorber, a nonion based water soluble polymer ultraviolet absorber, or the like can be presented.

The above-mentioned coloring agent is not particularly limited as long as it is a compound capable of providing a light absorbing property of a desired wavelength to the diffraction function layer in the present invention. As the coloring agent used in the present invention, for example, a pigment such as an azo based pigment, a bound azo based pigment, an isoindolinone based pigment, a quinacridone based pigment, a diketopyrolopyrol based pigment, an anthraquinone based pigment and a dioxazine based pigment, and a dye such as a 1,1 chromium complex based dye, a 1,2 chromium complex based dye, a 1,2 cobalt complex based dye, an anthraquinone based dye, a phthalocyanine based dye, a methine based dye, a lactone based dye, and a thioindigo based dye can be presented.

Moreover, to the diffraction function layer in the present invention, in addition to the above-mentioned additives, fine particles may be added for the purpose of adjusting the refractive index of the diffraction function layer. The refractive index of the fine particles to be added to the diffraction function layer can be determined optionally according to the refractive index required for the diffraction function layer, and in general it is preferably higher than the refractive index of the solid material for forming the diffraction function layer. Since such fine particles are used, the diffraction function layer may have a high refractive index. In particular, in the present invention, fine particles having the refractive index at a light having a 400 to 750 nm wavelength of the fine particles of 1.50 or more are preferable; moreover, fine particles having the refractive index of 1.70 or more; and furthermore, fine particles of 1.90 or more are further preferable.

Here, the refractive index at a light having a 400 to 750 nm wavelength is 1.50 or more denotes that the average refractive index at a light having a wavelength of the above-mentioned range is 1.50 or more so that the refractive index at the all lights having the wavelengths of the above-mentioned range needs not be 1.50 or more. Moreover, the average refractive index is a value obtained by dividing the total sum of the refractive index measurement values for each light having a wavelength in the above-mentioned range by the number of the measurement points.

As the fine particles having a high refractive index, for example, inorganic fine particles such as inorganic oxide fine particles, and organic fine particles, or the like can be presented. In particular, for the high transparency and the light transmitting property, the inorganic oxide fine particles are preferable. Since the inorganic oxide is colorless or barely colored, those having a high refractive index are suitable as a component for providing a high refractive index. As a light transmissible inorganic oxide having a high refractive index, a titanium oxide (TiO₂), a zinc oxide (ZnO), a zirconium oxide (ZrO₂), an indium/tin oxide (ITO), an antimony/tin oxide (ATO), or the like can be presented. As the titanium oxide, in particular, those of the rutile type having a high refractive index are preferable.

In order not to lower the transparency of the diffraction function layer, the primary particle size of the fine particles is preferably about 10 to 350 nm, and in particular, it is preferably about 10 to 100 nm. If the primary particle size is larger than the above-mentioned range, the transparency of the diffraction function layer may be deteriorated. Moreover, if the primary particle size is smaller than the above-mentioned range, aggregation can be generated easily so that even dispersion in the diffraction function layer may be difficult. Here, the primary particle size of the fine particles may be measured visually by the scanning type electron microscope (SEM), or the like, or it may be measured mechanically by a particle size distribution meter utilizing the dynamic light scattering method or the static light scattering method, or the like. Moreover, as long as the primary particle size of the fine particle is in the above-mentioned range, the particle shape may either be spherical or needle-like, or any other shape.

In the present invention, when the diffraction function layer is made of the solid material, the diffraction function layer in the present invention may be made of the same resin as the protection layer to be described later and integrally therewith. Since the diffraction function layer and the protection layer to be described later are formed integrally with the same resin, a computer generated hologram optical element having the further excellent rigidity can be formed.

The diffraction function layer in the present invention has the diffraction function showing a certain refractive index with respect to the image converting layer to be described later. For providing such a diffraction function by the diffraction function layer, the diffraction function layer may be present on the image converting layer, and the thickness thereof is not particularly limited. Since the diffraction function layer is present on the image converting layer, a certain refractive index difference can be provided. However, in consideration to the production suitability, or the like, of the computer generated hologram optical element of the present invention, the thickness of the diffraction function layer is preferably in a range of 0.5 μm to 50 μm, and it is particularly preferably in a range of 1 μm to 25 μm.

2. Protection Layer

Next, the protection layer in the present invention will be explained. The protection layer in the present invention has a function of preventing disturbance of the optical image to be obtained by the computer generated hologram optical element of the present invention due to the adhesion of water, oil, or the like onto the surface of the image converting layer to be described later. Hereinafter, the protection layer will be explained in detail.

Since the protection layer in the present invention transmits a light diffracted by the image converting layer to be described later, it preferably has the excellent light transmittance. In particular, the protection layer in the present invention preferably has an 80% or more transmittance in the visible light range, and more preferably 90% or more. If the transmittance is low, the optical image obtained by the computer generated hologram optical element of the present invention may be disturbed. Here, the transmittance of the protection layer can be measured by the JIS K7361-1 (Determination of the total light transmittance of plastic-transparent materials).

Moreover, as the protection layer of the present invention, those having a lower haze are preferable. Specifically, those having the haze value in a range of 0.01% to 5% are preferable; those in a range of 0.01% to 3% are more preferable; and those in a range of 0.01% to 1.5% are particularly preferable. Here, as the above-mentioned haze value, a value measured based on the JIS K7105 is used.

Furthermore, it is preferable that the protection layer has the excellent surface smoothness. If the surface of the protection layer is rough, a light incident from a point light source can be scattered by the protection layer so that the optical image obtained by the computer generated hologram optical element of the present invention may be disturbed.

The material for providing the protection layer of the present invention is not particularly limited as long as it has the above-mentioned characteristics. As such a material, either a rigid material without the flexibility such as a glass or a flexible material having the flexibility can be used, however, it is preferable to use a flexible material in the present invention. Since the flexible material is used, for example, the production process for a computer generated hologram optical element of the present invention can be the roll to roll process so that the computer generated hologram optical element of the present invention can be provided with the excellent productivity.

Since the flexible material is same as those mentioned in the item of the above-mentioned “1. Diffraction function layer”, the explanation thereof is not repeated here.

The protection layer in the present invention may contain another compound as an additive within a range not to deteriorate the purpose of the present invention. The above-mentioned additive is not particularly limited, and thus it can be selected optionally according to the application, or the like of the computer generated hologram optical element of the present invention. Since the compound is same as those mentioned in the above-mentioned item of “1. Diffraction function layer”, the explanation thereof is not repeated here.

The thickness of the protection layer in the present invention is not particularly limited as long as it is in a range of providing a rigidity to the extent not to break the minute concavo-convex shape formed in the surface of the image converting layer to be described later by the protection layer with the deformation derived from the external factors. The thickness may be determined optionally according to the kind of the constituent material of the protection layer, and it is in general preferably in a range of 0.5 μm to 10 mm, and it is particularly preferably in a range of 1 μm to 5 mm.

Moreover, as mentioned above, when the diffraction function layer is made of a solid material, the protection layer of the present invention may be provided integrally with the same resin as the material of the diffraction function layer. Accordingly, since the protection layer in the present invention is provided integrally with the same resin as the diffraction function layer, the hologram element used in the present invention can have the excellent rigidity.

Furthermore, printing may be applied to the surface of the protection layer in the present invention. Particularly in the case of using the computer generated hologram optical element of the present invention for the application as the toys such as the hologram observation tool, which is required to have a high design property, it is preferable to apply printing on the protection layer surface.

The printing method at the time of applying printing to the protection layer of the present invention is not particularly limited as long as it is a method capable of providing a desired design property to the protection layer. For example, a basic printing method such as planographic printing, intaglio printing, letterpress printing and screen printing, and an applied printing method thereof can be used. As the applied printing method, flexo printing, resin letterpress printing, gravure offset printing, pad printing, ink jet printing, transfer printing using a transfer foil, transfer printing using a thermally fusible or sublimation type ink ribbon, electrostatic printing, or the like can be used. Moreover, as to the technique, ultraviolet ray (UV) curing printing of curing an ink with an ultraviolet ray, baking printing of curing an ink at a high temperature, waterless offset printing not using dampening water, or the like can be used.

Moreover, the printing information to be provided by printing to the protection layer is not particularly limited. For example, letters, signs, marks, illustrations, characters, company names, product names, sales points, handling explanations, or the like can be presented.

3. Transmission Type Fourier Transform Hologram

Next, the transmission type Fourier transform hologram used in the present invention will be explained. The transmission type Fourier transform hologram used in the present invention comprises an image converting layer having a function as a Fourier transform lens, and a substrate for supporting the image converting layer. Hereinafter, the transmission type Fourier transform hologram will be explained in detail.

(1) Image Converting Layer

First, the image converting layer comprising the transmission type Fourier transform hologram in the present invention will be explained. The above-mentioned image converting layer has a function as a Fourier transform lens by the minute concavo-convex shape provided on the surface. According to the function, a light incident from an optional point light source is diffracted to a predetermined angle so as to form a predetermined image. Hereinafter, the image converting layer will be explained in detail.

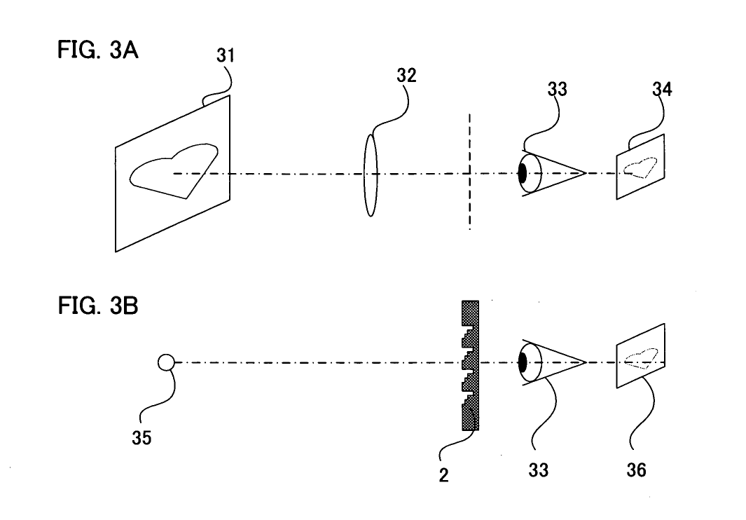

First, the Fourier transform lens function of the image converting layer will be explained. FIGS. 3A to 3B are schematic diagrams for respectively explaining the Fourier transform lens function of the image converting layer in the present invention. In FIGS. 3A to 3B, FIG. 3A is a schematic diagram for explaining the visual sight, and FIG. 3B is a schematic diagram for explaining the Fourier transform lens function of the image converting layer in the present invention. As shown in FIG. 3A, according to the visual sight, by the observation with human eyes 33 via a lens 32 of a desired image 31, an observation image 34 can be observed.

On the other hand, in FIG. 3B, according to the visual sight with the human eyes 33 through the image converting layer 2 of a point light source 35, an optical image 36 according to the concavo-convex shape formed on the surface of the image converting layer 2 can be observed. For example, if a concavo-convex shape for reproducing a heart image is provided in the image converting layer 2 as shown in FIG. 3B, an optical image 36 of the heart can be observed visually according to the visual observation of the point light source 35 through the image converting layer 2. As mentioned above, the Fourier transform lens function of the image converting layer in the present invention refers to the function of converting a light incident from a point light source into a desired optical image. Moreover, in the present invention, the Fourier lens function may be referred to also as the image converting function.

The wavelength of the point light source for realizing the function as the Fourier transform lens of the image converting layer in the present invention is not particularly limited, and a desired wavelength can be used as the subject. Moreover, the wavelength of the point light source is not limited to a monochromatic light of one wavelength, and it may be a light including multiple wavelengths, and furthermore, it may be a white light.

The material for providing the image converting layer is not particularly limited as long as it can form a minute concavo-convex shape for realizing the Fourier transform lens function, and providing a predetermined refractive index. The refractive index of the material comprising the image converting layer can be determined optionally according to the application or the like of the computer generated hologram optical element of the present invention, and thus it is not particularly limited. Moreover, the wavelength to be the reference of the refractive index is not particularly limited either, and thus it can be selected optionally in a range of 400 nm to 750 nm. In particular, in the present invention, it is preferable that the refractive index at the 633 nm wavelength is in a range of 1.3 to 2.0, and it is particularly preferably in a range of 1.33 to 1.8. Here, the refractive index can be measured with a spectral ellipsometer.

As the material for providing the image converting layer, various kinds of resin materials such as a thermosetting resin, a thermoplastic resin and an ionizing radiation cure resin used conventionally as a material for a relief type hologram forming layer can be used, and thus it is not particularly limited.

As the thermosetting resin, for example, an unsaturated polyester resin, an acrylic modified urethane resin, an epoxy modified acrylic resin, an epoxy modified unsaturated polyester resin, an alkyd resin, a phenol resin, or the like can be presented. Moreover, as the thermoplastic resin, for example, an ester acrylate resin, an amide acrylate resin, a nitro cellulose resin, a polystyrene resin, or the like can be presented.

These resins may be a single polymer or a copolymer made of two or more kinds of constituent components. Moreover, these resins may be used alone or as a combination of two or more kinds. These resins may optionally select and contain various kinds of isocyanate compounds; a metal soap such as a cobalt naphtheate and a zinc naphtheate; an organic peroxide such as a benzoyl peroxide, and a methyl ethyl ketone peroxide; and a heat or ultraviolet ray curing agent such as a benzophenone, an acetophenone, an anthraquinone, a naphthoquinone, an azobis isobutylonitrile, and a diphenyl sulfide.

As the ionizing radiation cure resin, for example, an epoxy modified acrylate resin, an urethane modified acrylate resin, an acrylic modified polyester, or the like can be presented. Among these examples, an urethane modified acrylate resin is particularly preferred, and an urethane modified acrylic based resin represented by the below-mentioned formula is particularly preferable.

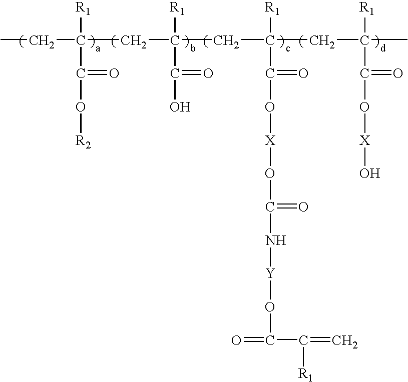

(wherein 5 R¹ represent each independently a hydrogen atom or a methyl group, R² represents a hydrocarbon group having C₁ to C₁₆, and X and Y respectively represents a straight chain or branched alkylene group. In the case (a+b+c+d) is 100, a is an integer of 20 to 90, b is 0 to 50, c is 10 to 80 and d is 0 to 20.)

The urethane modified acrylic based resin represented by the above-mentioned formula is for example, as a preferable example, an acrylic copolymer obtained by copolymerizing 20 to 90 moles of a methyl methacrylate, 0 to 50 moles of a methacrylic acid and 10 to 80 moles of a 2-hydroxy ethyl methacrylate, and a resin obtained by reacting a hydroxyl group present in the copolymer with a methacryloyloxy ethyl isocyanate (2-isocyanate ethyl methacrylate). Therefore, the methacryloyloxy ethyl isocyanate needs not be reacted with the all hydroxyl groups present in the copolymer, and at least 10 mole % or more, preferably 50 mole % or more of the 2-hydroxy ethyl methacrylate unit in the copolymer may be reacted with the methacryloyloxy ethyl isocyanate. Instead of, or in combination with the 2-hnydroxy ethyl methacrylate, a monomer having a hydroxyl group such as an N-methylol acrylic amide, an N-methylol methacrylic amide, a 2-hydroxy ethylacrylate, a 2-hydroxyethylmethacrylate, a 2-hydroxy propyl acrylate, a 2-hydroxy propyl methacrylate, a 4-hydroxy butyl acrylate, and a 4-hydroxy butyl methacrylate can be used as well.

As to the urethane modified acrylic based resin represented by the above-mentioned formula, by dissolving the copolymer by a solvent capable of dissolving the same, such as a toluene, a ketone, a cellosolve acetate and a dimethyl sulfoxide and dropping and reacting with a methacryloyloxy isocyanate while agitating the solution, the isocyanate group is reacted with the hydroxyl group of the acrylic based resin so as to generate an urethane bond so that a methacryloyl group can be introduced into the resin via the urethane bond. The use amount of the methacryloyloxy ethyl isocyanate used at the time is an amount to have an isocyanate group in a range of 0.1 to 5 moles based on 1 mole of a hydroxyl group by the ratio of the hydroxyl group of the acrylic based resin and the isocyanate group, and preferably 0.5 to 3 moles. In the case of using the methacryloyloxy ethyl isocyanate more than equivalent to the hydroxyl group in the above-mentioned resin, the methacryloyloxy ethyl isocyanate may generate a —CONH—CH₂CH₂— link by the reaction also with a carboxyl group in the resin.

In the example mentioned above, the all R¹ and R² are a methyl group and X and Y are an ethylene group in the above-mentioned formula, however, the present invention is not limited thereto. The 5 R¹ may be each independently a hydrogen atom or a methyl group. Furthermore, as the specific examples of R², for example, a methyl group, an ethyl group, an n- or iso-propyl group, an n-, iso- or tert-butyl group, a substituted or unsubstituted phenyl group, a substituted or unsubstituted benzyl group, or the like can be presented. As the specific examples of X and Y, an ethylene group, a propylene group, a diethylene group, a dipropylene group, or the like can be presented. The total molecular weight of the urethane modified acrylic based resin obtained accordingly is 10,000 to 200,000 by the standard polystyrene based weight average molecular weight measured by the GPC, and it is further preferably 20,000 to 40,000.

At the time of curing the ionizing radiation cure resin as mentioned above, for the purpose of adjusting the cross linking structure, the viscosity, or the like, together with the monomer, a monofunctional or polyfunctional monomer, an oligomer, or the like as mentioned below can be used in combination.

As the monofunctional monomer, for example, a mono (meth)acrylate such as a tetrahydrofulfuryl (meth)acrylate, a hydroxylethyl(meth)acrylate, a vinyl pyrrolidone, a (meth)acryloyloxy ethyl succinate, and a (meth)acryloyloxy ethyl phthalate can be presented. As a bifunctional or more monomer, according to the skeleton structure classification, a polyol (meth)acrylate (for example, an epoxy modified polyol (meth)acrylate, a lactone modified polyol (meth)acrylate, or the like), a polyester (meth)acrylate, an epoxy(meth)acrylate, an urethane (meth)acrylate, and additionally, a poly(meth)acrylate having a skeleton of the polybutadiene based, the isocyanuric acid based, the hidantoin based, the melamine based, the phosphoric acid based, the imide based, the phosphazene based, or the like can be presented. Various ultraviolet ray or electron beam curing type monomers, oligomers and polymers can be utilized.

Further specifically, as the bifunctional monomers and oligomers, for example, a polyethylene glycol di(meth)acrylate, a polypropylene glycol di(meth)acrylate, a neopentyl glycol di(meth)acrylate, a 1,6-hexane diol di(meth) acrylate, or the like can be presented. Moreover, as the trifunctional monomers, oligomers and polymers, for example, a trimethylol propane tri(meth)acrylate, a pentaerythritol tri(meth)acrylate, an aliphatic tri(meth) acrylate, or the like can be presented. Moreover, as the tetrafunctional monomers and oligomers, for example, a pentaerythritol tetra(meth)acrylate, a ditrimethylol propane tetra(meth)acrylate, an aliphatic tetra(meth)acrylate, or the like can be presented. Moreover, as the pentafunctional or more monomers and oligomers, for example, a dipentaerythritol penta(meth)acrylate, a dipentaerythritol hexa(meth)acrylate, or the like can be presented, and furthermore, a (meth) acrylate having a polyester skeleton, an urethane skeleton or a phosphazene skeleton, or the like can be presented. Although the functional group number is not particularly limited, if the functional group number is less than 3, the heat resistance tends to be lower, and furthermore, when it is over 20, the flexibility tends to be lowered, and thus those having a 3 to 20 functional group number are particularly preferable.

The use amount of the monofunctional or polyfunctional monomers and oligomers as mentioned above may be determined optionally according to the production method for an image converting layer, or the like. It is in general preferably in a range of 0 part by weight to 50 parts by weight with respect to 100 parts by weight of the ionizing radiation cure resin, and it is particularly preferably in a range of 0.5 part by weight to 20 parts by weight.

Furthermore, as needed, to the image converting layer in the present invention, additives such as a photo polymerization initiating agent, a polymerization inhibiting agent, a deterioration preventing agent, a plasticizing agent, a lubricating agent, a coloring agent such as a dye and a pigment, a filling agent such as an extender pigment and a resin for the amount increase or preventing blocking, a surfactant, an antifoaming agent, a leveling agent, a thixotropic property providing agent, or the like can be added optionally.

(2) Substrate

Next, the substrate comprising the transmission type Fourier transform hologram used in the present invention will be explained. The substrate used in the present invention supports the image converting layer, and it has the function of transmitting an optical image formed in the image converting layer.

The substrate used in the present invention is not particularly limited as long as it has the self supporting property capable of supporting the image converting layer and the light transmitting property capable of transmitting the optical image formed in the image converting layer. In particular, it is preferable that the substrate in the present invention has an 80% or more transmittance in the visible light region, and more preferably 90% or more. In the case the transmittance is low, the optical image obtained by the computer generated hologram optical element of the present invention may be disturbed. Here, the transmittance of the substrate can be measured by the JIS K7361-1 (Determination of the total light transmittance of plastic-transparent materials).

Moreover, as the substrate of the present invention, those having a lower haze are preferable. Specifically, those having the haze value in a range of 0.01% to 5% are preferable; those in a range of 0.01% to 3% are more preferable; and those in a range of 0.01% to 1.5% are particularly preferable. Here, as the haze value, a value measured based on the JIS K7105 is used.

The material for providing the substrate used in the present invention is not particularly limited as long as it has the above-mentioned characteristics. For example, a plastic resin film and a glass plate can be used. In particular, in the present invention, it is preferable to use a plastic resin film as the substrate because the plastic resin film is lightweight and it has little risk of breakage unlike the case of a glass.

The resin for providing the plastic resin film is not particularly limited as long as it has the rigidity capable of supporting the image converting layer. As such a plastic resin, for example, a polyethylene terephthalate, a polyvinyl chloride, a polyvinylidene chloride, a polyethylene, a polypropylene, a polycarbonate, a cellophane, an acetate, a nylon, a polyvinyl alcohol, a polyamide, a polyamide imide, an ethylene-vinyl alcohol copolymer, a polymethyl methacrylate, a polyether sulfone, a polyether ether ketone, or the like can be presented. In particular, in the present invention, from the viewpoint of the birefringence, it is preferable to use a polycarbonate.

The thickness of the substrate used in the present invention is not particularly limited as long as it is in a range of providing the rigidity capable of supporting the image converting layer according to the application, or the like of the computer generated hologram optical element of the present invention. The specific thickness of the substrate can be determined optionally according to the material for providing the substrate. In particular, in the present invention, the thickness of the substrate is preferably in a range of 5 μm to 200 μm, and it is particularly preferably in a range of 10 μm to 50 μm.

Furthermore, the substrate in the present invention may have printing applied on the surface. Particularly when the computer generated hologram optical element of the present invention is used for the application as the toys such as the hologram observation tool, which is required to have a high design property, it is preferable to apply printing on the substrate surface. Since the printing method and the printing information at the time of applying printing are same as the content mentioned in the above-mentioned item of “2. Protection layer”, the explanation thereof is not repeated here.

4. Computer Generated Hologram Optical Element

The computer generated hologram optical element of the present invention may have a configuration other than the above-mentioned. As such another configuration, an anti-reflection layer can be presented. By providing an anti-reflection layer, for example, since disturbance of the image derived from the multiple reflection of the incident light, or the like can be prevented, it is preferable that the computer generated hologram optical element of the present invention has an anti-reflection layer.

When the computer generated hologram optical element of the present invention has an anti-reflection layer as the above-mentioned other configuration, the position for forming the anti-reflection layer is not particularly limited as long as it is the air interface of the computer generated hologram optical element of the present invention. Moreover, the anti-reflection layer may be formed not only by one layer but also by two or more layers.

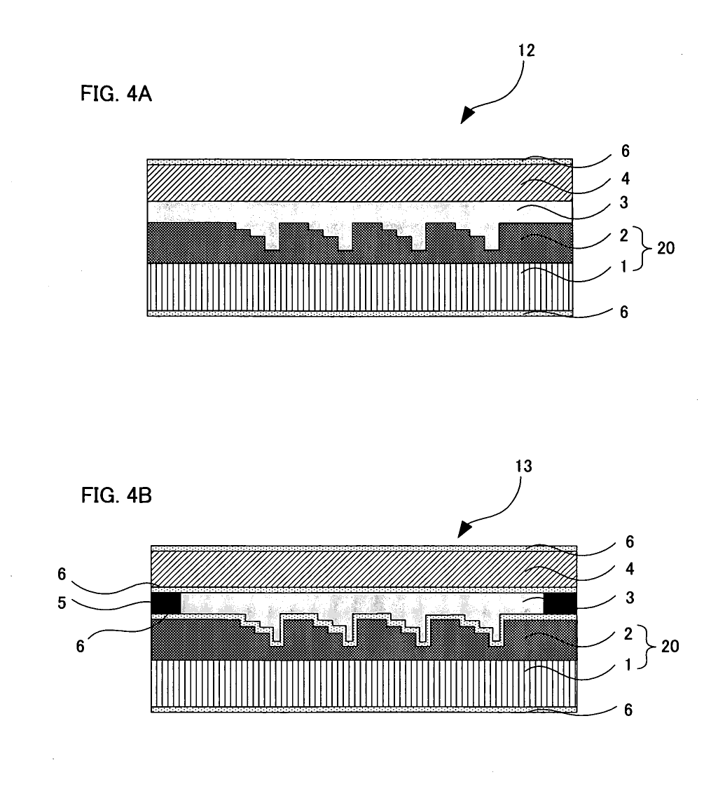

An embodiment when the computer generated hologram optical element of the present invention comprises the anti-reflection layer will be explained with reference to the drawings. FIG. 4A is a schematic cross sectional view showing an example of an embodiment with the anti-reflection layer formed on the computer generated hologram optical element of the present invention. Moreover, FIG. 4B is a schematic cross sectional view showing an example of an embodiment with the anti-reflection layer formed in the computer generated hologram optical element having the diffraction function layer made of air.

As shown in FIG. 4A, as an embodiment with the anti-reflection layer 6 formed in the computer generated hologram optical element 12 of the present invention, an embodiment formed on the surface of the protection layer 4 and the substrate 1 can be presented. Moreover, as shown in FIG. 4B, as an embodiment of the anti-reflection layer 6 when the diffraction function layer 3 is made of air, an embodiment formed on the interface of the diffraction function layer 3 and the protection layer 4, and the interface of the diffraction function layer 3 and the image converting layer 2 in addition to the respective surface of the protection layer 4 and the substrate 1 can be presented.

In the present invention, as an embodiment with the anti-reflection layer formed, an embodiment formed only in the uppermost layer as shown in FIG. 4A, and an embodiment formed in the uppermost layer and the inner layer as shown in FIG. 4B can be presented. In the present invention, either embodiment can be used preferably. For example, the embodiment formed only in the uppermost layer as shown in FIG. 4A is preferable in the case of using the hologram observation tool of the present invention for the toy application such as a hologram observation tool which does not require having a high quality optical image. On the other hand, the embodiment formed in the uppermost layer and the inner layer as shown in FIG. 4B is preferable in the case of using the hologram observation tool of the present invention for the industrial application such as a beam shaper for the laser process which is required to have a highly precise optical image.

As the constituent material for the anti-reflection layer, for example, a fluorine containing material, a silicone containing material, and a resin containing fine particles made of these materials can be used. More specifically, the materials disclosed in the JP-A No. 2003-183592, or the like can be used. Moreover, when the anti-reflection layer is formed on the protection layer, a material having a refractive index lower than that of the protection layer can be used preferably.

Furthermore, the thickness of the anti-reflection layer is not particularly limited as long as it is in a range capable of restraining the reflection of an incident light to a desired extent according to the kind of the material for providing the anti-reflection layer. In general it is preferably in a range of 0.01 μm to 2 μm, and it is particularly preferably in a range of 0.05 μm to 1 μm.

The application of the computer generated hologram optical element of the present invention is not particularly limited as long as the function as the Fourier transform lens of the computer generated hologram optical element of the present invention can be utilized. For example, the application as a toy such as a hologram observation tool, the application as a beam shaper for laser patterning, and additionally, the application as a optical branching element and a distance measuring light source, or the like can be presented.

5. Production Method for a Computer Generated Hologram Optical Element

Next, the production method for a computer generated hologram optical element of the present invention will be explained. The production method for a computer generated hologram optical element of the present invention is not particularly limited as long as it is a method capable of producing a computer generated hologram optical element having the above-mentioned configuration, and thus it can be produced by combining the generally known methods. Hereinafter, as an example of the production method for a computer generated hologram optical element of the present invention, a method of forming a transmission type Fourier transform hologram by forming an image converting layer on a substrate, and laminating a diffraction function layer and a protection layer successively on the image converting layer will be explained.

First, a method of forming a transmission type Fourier transform hologram by forming an image converting layer on a substrate will be explained. The method for forming an image converting layer on a substrate is not particularly limited as long as it is a method capable of forming an image converting layer having a predetermined concavo-convex shape on the surface on the substrate. It is in general formed by a method of producing a hologram master of a concavo-convex shape to be provided to the image converting layer, and transferring the concavo-convex shape onto the image converting layer using the hologram master.

The production method for the hologram master is not particularly limited, and a common method can be used. As such method, for example, after determining an optical image to be obtained by the computer generated hologram optical element of the present invention, data of the optical image are produced; the Fourier transform data are calculated from the position of the Fourier transform surface, or the like; and the Fourier transform data are converted to rectangular data for the electron beam drawing. Then, by the method of drawing the minute concavo-convex shape onto a resist surface coated on a glass plate by an electron beam lithography system for drawing the rectangular data onto a semiconductor circuit mask, or the like, it can be produced.

As the method for transferring the concavo-convex shape onto the image converting layer using the hologram master produced by the above-mentioned method, the known 2P method, injection molding method, sol gel process, hard emboss, soft emboss, semi dry emboss, various kinds of nano imprint method, or the like can be used. In particular, in the present invention, it is preferable to use the 2P method. According to the 2P method, simultaneously with the formation of the image converting layer on the substrate, the minute concavo-convex shape can be formed on the surface of the image converting layer.

Next, the method for transferring the minute concavo-convex shape to the image converting layer by the above-mentioned 2P method (photo polymerization method) will be explained. The minute concavo-convex shape transfer method by the 2P method is a method for transferring the minute concavo-convex shape to an image converting layer by dropping an image converting layer forming composition on a hologram master, directing an active radiation with the substrate placed on the image converting layer forming composition for curing, and peeling off. The 2P method is known in general as a method effective for forming a concavo-convex relief on a substrate so that it is used also for copying the known optical parts, or the like.

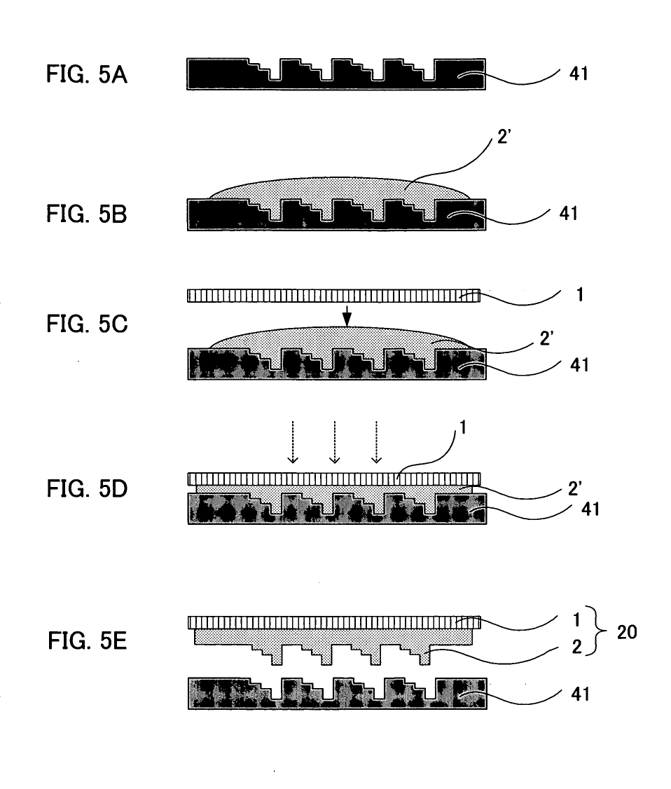

The method for transferring the minute concavo-convex shape by the above-mentioned 2P method will be explained with reference to the drawings. FIGS. 5A to 5E are a schematic diagram for explaining the 2P method. As shown in FIGS. 5A to 5E, according to the 2P method, a hologram master 41 with the concavo-convex shape formed is prepared (FIG. 5A). Then, an image converting layer forming composition 2′ is dropped (FIG. 5B), and a substrate 1 is placed thereon and pressed (FIG. 5C).

Then, by directing an active radiation such as an ultraviolet ray from the hologram master 41 or the substrate 1, the image converting layer forming composition 2′ is hardened (FIG. 5D).

Then, the image converting layer forming composition hardened and bonded with the substrate 1 is peeled off from the hologram master 41 side together with the substrate 1 (FIG. 5E). According to the method, a transmission type Fourier transform hologram 20 with the image converting layer 2 having a concavo-convex shape on the substrate 1 formed can be formed.

Since the material used for the image converting layer forming composition and the substrate are same as those explained in the above-mentioned item of “3. Transmission type Fourier transform hologram”, the explanation thereof is not repeated here.

Next, the method for laminating a diffraction function layer and a protection layer successively on the image converting layer of the transmission type Fourier transform hologram produced by the above-mentioned method will be explained. The method for successively laminating the diffraction function layer and the protection layer on the image converting layer differs depending on the form of the material for providing the diffraction function layer.

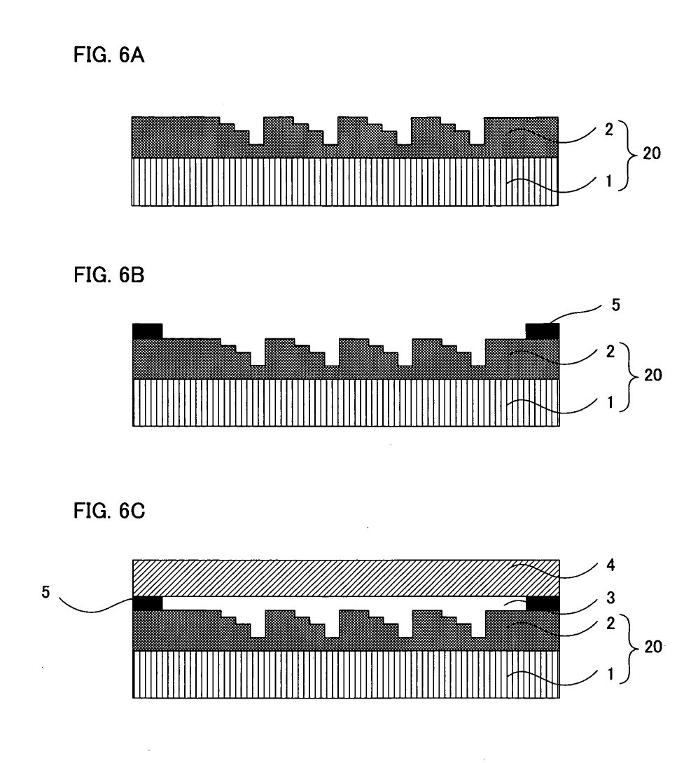

When the diffraction function layer is made of a gas such as air, for example, by forming a protection layer on the image converting layer of the transmission type Fourier transform hologram, the diffraction function layer made of air and the protection layer can be laminated. The method will be explained with reference to FIGS. 6A to 6C. As shown in FIGS. 6A to 6C, when the diffraction function layer is made of air, by providing a spacer 5 having a predetermined thickness on the image converting layer 2 (FIGS. 6A and 6B) and attaching the protection layer 4 on the spacer 5, the diffraction function layer 3 and the protection layer 4 can be formed at the same time (FIG. 6C). Moreover, the spacer 5 may be attached to the diffraction function layer 3 after being formed on the protection layer 4. In this case, the spacer 5 may also have the function as an adhesive for bonding the image converting layer 2 and the protection layer 4.

The above-mentioned method for forming the diffraction function layer made of air as shown in FIGS. 6A to 6C is preferable in the case of for example producing a computer generated hologram optical element for the laser process beam shaper application, which is required to obtain a highly precise optical image.

On the other hand, in the case of producing a computer generated hologram optical element for the toy application such as a hologram observation tool, when the diffraction function layer is made of air, the image converting layer and diffraction function layer may be bonded with an optional adhesive so as to form an air layer between the image converting layer and diffraction function layer without the need of using a spacer as shown in FIGS. 6B and 6C.

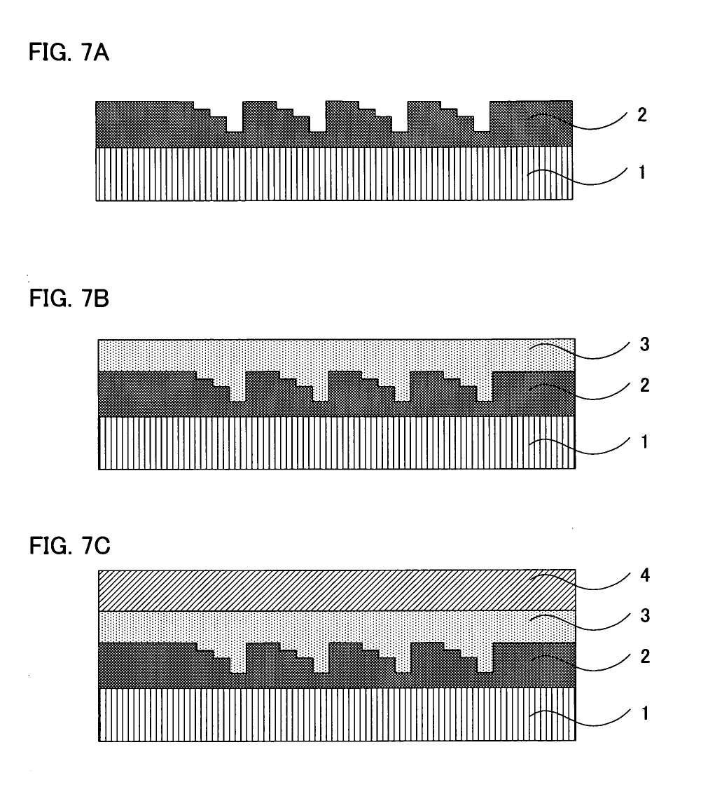

When the diffraction function layer is made of a solid material, by laminating a protection layer on the diffraction function layer after forming a diffraction function layer using a diffraction function layer forming composition on the image converting layer of the transmission type Fourier transform hologram, a computer generated hologram optical element of the present invention can be formed. The method will be explained with reference to FIGS. 7A to 7C. As shown in FIGS. 7A to 7C, when the diffraction function layer is formed with a solid material, after coating a diffraction function layer forming composition on the image converting layer 2 so as to form a diffraction function layer 3 (FIGS. 7A, 7B), by forming a protection layer 4 on the diffraction function layer 3 (FIG. 7C), a computer generated hologram optical element of the present invention can be formed.

Moreover, by not forming the protection layer after forming the diffraction function layer, a computer generated hologram optical element of an embodiment with the diffraction function layer and the protection layer formed integrally with the same resin can be formed.

Here, since the material used for the diffraction function layer forming composition is same as that mentioned in the above-mentioned item of “1. Diffraction function layer”, the explanation thereof is not repeated here. Moreover, the method for coating the diffraction function layer forming composition on the image converting layer is not particularly limited and a common method can be used.

The present invention is not limited to the above-mentioned embodiments. The above-mentioned embodiments are examples, and thus any case having the substantially same configuration as the technological idea disclosed in the claims of the present invention with the same effects is incorporated in the technological scope of the present invention.

### EXAMPLES

### 1. Example 1

### Computer Generated Hologram Optical Element with the Diffraction Function Layer Made of Air

(1) Production of the Transmission Type Fourier Transform Hologram

A resist layer was formed by rotation coating of a resist for dry etching with a spinner onto the chromium thin film of a photo mask blank plate with a surface low reflection chromium thin film laminated onto a synthetic quartz substrate. As the resist for dry etching, ZEP 7000 produced by ZEON CORPORATION was used, and the thickness of the resist layer was 400 nm. With an electron beam lithography system (MEBES 4500: produced by Etec Systems, Inc.), a pattern preliminarily formed with a computer was exposed on the resist layer formed accordingly. After sectioning and forming an easily soluble portion with the resist resin hardened by the exposure and an unexposed portion, the solvent development was carried out by the spray development of spraying a developing solution, or the like so as to remove the easily soluble portion for forming a resist pattern.

By utilizing the resist pattern formed by the above-mentioned method, the chromium thin film in a portion not covered with the resist was removed by dry etching so as to expose the quartz substrate of the lower layer in the removed portion. Then, by etching the exposed quartz substrate, a concave portion generated according to the procedure of the etching and the projecting portion comprising the quartz substrate original portion covered with the chromium thin film and the resist thin film successively from below were formed. Furthermore, by dissolving and removing the resist thin film, a quartz substrate having a concave portion generated by etching the quartz substrate and the projecting portion having a portion with the chromium thin film laminated at the top part was obtained.

To the concavo-convex shape hologram master produced as mentioned above, an image converting layer forming composition (UV curing acrylate resin: refractive index 1.52, measurement wavelength 633 nm) was dropped. A polycarbonate substrate was placed thereon, and pressured. Then, by directing an active radiation (using an H valve produced by Fusion UV Systems Japan KK., irradiation amount 500 mJ), the image converting layer forming composition was peeled off after curing so as to produce a transmission type Fourier transform hologram having a concavo-convex image with the concavo-convex shape of the hologram master reversed.

(2) Production of the Protection Layer and the Diffraction Function Layer

A protection layer forming member was prepared by screen printing in a pattern on an acrylic plate (product name: PARAGLAS®, thickness 2 μm: produced by KURARAY CO., LTD.) with a coating solution (CAT-1300S: produced by Teikoku Printing Inks Mfg. Co., Ltd.) as a spacer and an adhesive, and attaching a mold releasing paper on the printed surface. The pattern of the pattern printing was applied such that the spacer and the adhesive are provided on the image converting layer with no production of the concavo-convex shape. The thickness of the spacer and adhesive was 2 μm.

With the mold releasing paper of the production layer forming member produced as mentioned above removed, it was pressed and attached to the concavo-convex surface side of the transparent substrate with the produced image converting layer formed. By the punching process to a predetermined size (5 cm×5 cm) of the attached one, a computer generated hologram optical element provided integrally with the protection layer was produced.

### 2. Example 2

### Computer Generated Hologram Optical Element with the Protection Layer and the Diffraction Function Layer Formed Integrally

The below-mentioned diffraction function layer forming composition was coated onto the image converting layer of the transmission type Fourier transform hologram produced in the example 1 so as to have the film thickness after drying and UV curing of 5 μm. By eliminating the solvent by drying (60° C., 1 minute) and curing by the UV irradiation (using a H bulb produced by Fusion UV Systems Japan KK., irradiation amount 500 mJ), a diffraction function layer having a 1.83 refractive index (measurement wavelength: 633 nm) was formed. In the example 2, with the refractive index of the image converting layer (1.52) and the refractive index of the diffraction function layer (1.83), an embedded type computer generated hologram optical element with an image converting layer having a minute concavo-convex shape of D=1.531 μm, N=4 was produced based on the calculation formula.

<Composition of the Diffraction Function Layer Forming Composition>

Titanium oxide (TTO51(C): product name, produced by ISHIHARA SANGYO KAISHA, LTD.I): 10 parts by weight
Pentaerythritol triacrylate (PET30: product name, produced by NIPPON KAYAKU CO., LTD.):4 parts by weight
Anionic polarity group containing dispersing agent (Disperbyk 163: product name, produced by BYK Chemie Japan KK): 2 parts by weight
Photo polymerization initiating agent (IRGACURE 184: product name, produced by Nihon Ciba-Geigy K.K.): 0.2 part by weight
Methyl isobutyl ketone: 16.2 parts by weight

What is claimed is:

1. A computer-generated hologram optical element comprising: a transmission type Fourier transform hologram comprising a substrate, and an image converting layer formed on the substrate and having a function as a Fourier transform lens;
a diffraction function layer disposed on the image converting layer of the transmission type Fourier transform hologram and having a certain refractive index difference with respect to the image converting layer; and
a protection layer formed on the diffraction function layer.

2. The computer-generated hologram optical element according to claim 1, wherein the diffraction function layer is made of air.

3. The computer-generated hologram optical element according to claim 1, wherein the diffraction function layer and the protection layer are formed integrally with a same resin.

4. The computer-generated hologram optical element according to claim 1, wherein the refractive index difference between the diffraction function layer and the image converting layer is in a range of 0.75×(λ₀/D)×(N−1)/N to 1.25×(λ₀/D)×(N−1)/N,
(in which the λ₀ is a reference wavelength, the D is a maximum depth of a minute concavo-convex shape formed on a surface of the image converting layer, and the N is number of steps of the minute concavo-convex shape formed on the surface of the image converting layer).

5. The computer-generated hologram optical element according to claim 2, wherein the refractive index difference between the diffraction function layer and the image converting layer is in a range of 0.75×(λ₀/D)×(N−1)/N to 1.25×(λ₀/D)×(N−1)/N,
(in which the λ₀ is a reference wavelength, the D is a maximum depth of a minute concavo-convex shape formed on a surface of the image converting layer, and the N is number of steps of the minute concavo-convex shape formed on the surface of the image converting layer).

6. The computer-generated hologram optical element according to claim 3, wherein the refractive index difference between the diffraction function layer and the image converting layer is in a range of 0.75×(λ₀/D)×(N−1)/N to 1.25×(λ₀/D)×(N−1)/N,
(in which the λ₀ is a reference wavelength, the D is a maximum depth of a minute concavo-convex shape formed on a surface of the image converting layer, and the N is number of steps of the minute concavo-convex shape formed on the surface of the image converting layer).

7. The computer-generated hologram optical element according to claim 1, wherein printing is applied to the protection layer.

8. The computer-generated hologram optical element according to claim 2, wherein printing is applied to the protection layer.

9. The computer-generated hologram optical element according to claim 3, wherein printing is applied to the protection layer.

10. The computer-generated hologram optical element according to claim 1, wherein the optical element comprises an anti-reflection layer.

11. The computer-generated hologram optical element according to claim 2, wherein the optical element comprises an anti-reflection layer.

13. The computer-generated hologram optical element according to claim 3, wherein the optical element comprises an anti-reflection layer.
